(19) United States
(12) Patent Application Publication
(10) Pub. No.: US 2023/0316878 A1
(43) Pub. Date: Oct. 5, 2023

(54) TILL SYSTEM

(71) Applicants: Juergen KRONE, Koeln (DE); Michael Veiser, Muelheim an der Ruhr (DE)

(72) Inventors: Juergen KRONE, Koeln (DE); Michael Veiser, Muelheim an der Ruhr (DE)

(21) Appl. No.: 17/992,337

(22) Filed: Nov. 22, 2022

(30) Foreign Application Priority Data
Apr. 4, 2022 (EP) 22166521.9

(51) Int. Cl. G07G 1/00; G06Q 20/20

(52) U.S. Cl. CPC G07G 1/0018; G06Q 20/208; G06Q 20/204

(57) ABSTRACT

A till system for goods has a counter having upstream and downstream end, an input device at a cashier station between the ends, a conveyor displacing the goods along the counter toward the downstream end, and a scanner between the ends for identifying characteristics of the goods moved past the scanner by the conveyor and feeding data representing the identified characteristics of the goods to the input device. First and second goods bays are provided at the downstream end adapted to hold the scanned goods and are transversely spaced with respect to the direction. Respective separate first and second payment devices are provided at the first and second good bays for processing payments for the goods in the respective bays such that, while payment is being processed for the goods in one of the bays, goods can be scanned and fed to the other of the bays.

### FIELD OF THE INVENTION

The present invention relates to a till system. More particularly this invention concerns such a system for retail goods.

### BACKGROUND OF THE INVENTION

A typical till system for goods in a retail establishment where the customer collects purchases in a shopping cart that is emptied by a cashier at the till system has a counter, an input device, an electronic scanner for the goods, a conveyor belt for the goods, and at least two goods bays at the end of the goods flow. Such a system is described, for example, in EP 1 090 570 of applicant. It has a special L-shaped parking station for a shopping cart for ergonomic goods flow and extending from a price/quantity reading device for convenient filling of the shopping cart. The price/quantity reading device typically is an electronic product scanner for reading barcodes adhered to the goods to be scanned. The device scans the price and, if applicable, determines the quantity of the goods concerned, for calculating the total price in the electronic input device.

A comparable state of the art is disclosed in DE 203 00 926. The main objective here is to optimize the entry area in conjunction with an access door to the till system.

The till system disclosed in DE 20 2019 103 238 has an adjoining goods bay that is detachable from the counter. This enables easy and flexible adaptation to actual shopper behavior.

As part of the generic state of the art according to DE 20 2009 010 397, the till system comprises two goods bays at the end of the goods flow of the counter. That makes it feasible to serve multiple customers at the till system simultaneously. However, this design only provides one card reader and one input device in conjunction with a cash drawer, which means that the processing and/or payment transaction of individual customers is not truly accelerated.

### OBJECTS OF THE INVENTION

It is therefore an object of the present invention to provide an improved till system.

Another object is the provision of such an improved till system that overcomes the above-given disadvantages, in particular that increases the customer throughput and accelerates the speed of processing individual customers.

### SUMMARY OF THE INVENTION

A till system for goods has according to the invention a counter having an upstream end and a downstream end, an input device at a cashier station between the ends, a conveyor for displacing the goods along the counter in a direction from the upstream end toward the downstream end, and a scanner between the ends for identifying characteristics of the goods moved past the scanner by the conveyor and feeding data representing the identified characteristics of the goods to the input device. First and second goods bays are provided at at the downstream end adapted to hold the scanned goods and are transversely spaced with respect to the direction. Respective separate first and second payment devices are provided at the first and second good bays for processing payments for the goods in the respective bays such that, while payment is being processed for the goods in one of the bays, goods can be scanned and fed to the other of the bays.

According to the invention, the design features two goods bays arranged at the end of the goods flow of the counter. As a special feature and in addition to the generic state of the art according to above-cited DE 20 2009 010 397 Ul, the present invention allocates a separate electronic payment device to each goods bay. This electronic payment device is not set up for cash payment, as is typically observed for the input device in the counter. Rather, the electronic payment device is used to conduct an exclusively electronic and cashless payment transaction.

In the simplest case, this may be effected and completed by scanning a card such as a customer's EC debit or credit card. In principle, the electronic payment device may also be used for processing electronic payment transactions via a customer's mobile phone or using other cashless electronic processes. Either way, the electronic payment device is ultimately characterized in that the payment transaction takes place virtually autonomously and without involvement of the typically present cashier, although the cashier may have a control function in this context. Either way, the time cashier's time normally wasted during the autonomous payment transaction between the customer and the relevant electronic payment device and its duration is according to the invention according to the invention, to scan the goods of a second customer via the electronic scanner while the electronic payment transaction is processing.

This enables a partial time overlap between succeeding checkout processes. This results in a considerable acceleration of the checkout process and the processing of individual customers, as the scanning of the second customer's goods previously had to wait until the first customer's payment transaction was successfully completed.

According to the invention, this wait is now no longer necessary. Rather, the first customer's payment transaction and scanning the second customer's goods overlap in time. It may even be feasible for the second customer's payment transaction to start while the first customer's payment transaction is still processing. The invention is based on the insight that increasing numbers of such payment transactions for purchases of goods, and particularly retail goods, nowadays are processed electronically. This typically occurs without involvement of the cashier, which means that this wasted time may be utilized advantageously to serve a second customer. That also applies if any problems arise during the first customer's payment transaction, as processing of the second customer is completely separate.

In this manner, the invention considerably accelerates the payment transaction, which not only increases the turnover of goods per till system, but also enhances customer satisfaction and checkout efficiency. This constitutes the main advantages. In one advantageous embodiment, each of the payment devices is connected to respective arm, in particular a pivotal arm. This makes their operation especially simple, intuitive and ergonomic because customers may adjust and individually position the payment device during the payment transaction. This is complemented by the fact that both payment devices advantageously are arranged laterally on opposite sides of the checkout counter whose the base element has the two goods bays at its downstream end. The two goods bays are thus usually located at the downstream end of the counter base element, which is typically arranged past the cashier station and generally encloses it.

The counter may feature a largely level surface in which the conveyor belt for the goods is integrated. The counter generally features base elements having shelves for goods or shopping bags below and to the side.

The two payment devices usually each have a respective card reader and a printer. The card reader enables any necessary data exchange involving a customer's data media, such as a credit card, an EC debit card or a customer loyalty card. In principle, this may also be a mobile phone or the like so that the electronic payment transaction is initiated via customer communication. The printer may be used to generate a receipt of the payment transaction so that the purchased goods may be detailed on an associated till receipt. All of this occurs essentially without the intervention of a cashier and only requires a simple dialogue between the customer and the electronic payment device. The cashier may have a control function in this context if necessary.

The two goods bays are generally separated from one another by a physical goods separator that is a pivotal horizontal bar to turn around a vertical axis. This enables the cashier occupying the cashier station to direct the first customer's and the second customer's flow of goods to the respective goods bays.

In addition, the design usually features a parking station for a shopping cart immediately downstream of each of the two goods bay. The parking stations may each have a strip-shaped bumper at the respective goods bay to help position a shopping cart. Furthermore, the parking station generally includes indicia indicating the position of the shopping cart. In the simplest case, this indicia may be an imprint or a painted marker or the like on the floor. In principle, the parking station may also be contactless, namely an image projection on the relevant floor.

In most cases, the design includes indicia of the shopping cart position as well as a indicia for the customer. In the simplest case, this may be a stylized footprint to show customers the best position for standing when loading their shopping carts. Again, the indicia for the customer may be designed and arranged as a general projection on the floor. In addition, it has proved useful to arrange the second goods bay as an extension of the conveyor belt for processing the goods of a second customer. This design results in especially intuitive customer flow. In this manner, the goods of the first customer are processed in the first goods bay, which is arranged parallel to the second goods bay and thus, offset relative to the conveyor belt. This ensures that the parking station located in an extension of the conveyor belt as well as the second goods bay, is accessible to the second customer during the payment transaction of the first customer.

Since the second customer's shopping cart moves along the conveyor belt, the second customer is able to directly use the parking station adjoining the second goods bay in extension of the conveyor belt, which is particularly intuitive and obvious.

The invention also relates to a method for operating such a till system for goods as described above. As a special feature, it must be taken into account that the cashier occupying the cashier station initiates the payment transaction of the first customer at the first payment device of the first goods bay. This may be done by fully scanning the goods of the first customer. The actual payment transaction then occurs based on interaction of the first customer and the first payment device without intervention or even attention by the cashier. The cashier may initiate or trigger the respective payment transaction by closing the sale. After scanning the first customer's goods and initiating the payment transaction, the respective cashier may then use the electronic scanner to scan the second customer's goods. The status of the respective goods bay may be reflected in a display and is usually specified automatically by the till system or an associated control unit. For example, the status of the respective bay may correspond to different color displays. The display is a part of the till system and may, for example, be designed as a digital display. Thus, a green color coding of the relevant goods bay indicates that it is available for a customer's goods. Yellow color coding shows that the relevant goods bay is in use, for example because the first customer's payment transaction is being processed. Finally, a display in red color shows, for example, that a problem was observed during the first customer's payment transaction.

Furthermore, the design of the present invention offers the customer the option to either pay at the till or at the payment device allocated to the respective goods bay. Payments made at the till generally involve cash, while the electronic payment device is used to process the above-described electronic payment transaction. If the customer is making a cash payment at the till, the till system will not be released for the second customer's goods, since the cashier in this case is focused on the payment transaction and is therefore not available to scan the second customer's goods by using an electronic scanner. This means that in the case of a payment transaction by the first customer at the till, the second customer's goods will be scanned once the payment transaction is completed as the payment transaction in this case involves cash and the cashier must focus on this transaction.

Accordingly, the invention provides a till system for goods and particularly retail goods, which, in addition to allowing a flexible cash and cashless payment method, offers the feasibility of considerably speeding up customer processing based on an electronic payment transaction. This, however, presumes that the customer uses an electronic payment transaction. In fact the system may be used in such a way that the cashier, during the payment transaction of the first customer at the first payment device of the first goods bay, is able to scan the goods of the second customer during this payment transaction by using the electronic scanner. The respective goods may simultaneously be transferred to the second goods bay, which substantially increases customer flow and throughput and improves customer satisfaction. This constitutes the main advantages.

### BRIEF DESCRIPTION OF THE DRAWING

The above and other objects, features, and advantages will become more readily apparent from the following description, reference being made to the accompanying drawing in which:

FIG. 1 is a schematic top view of a till system according to the invention;

FIG. 2 is a perspective view of the till system according to FIG. 1 toward the two parking stations and the goods bays; and

FIG. 3 is a different perspective view of the inventive till system with the two goods bays.

### SPECIFIC DESCRIPTION OF THE INVENTION

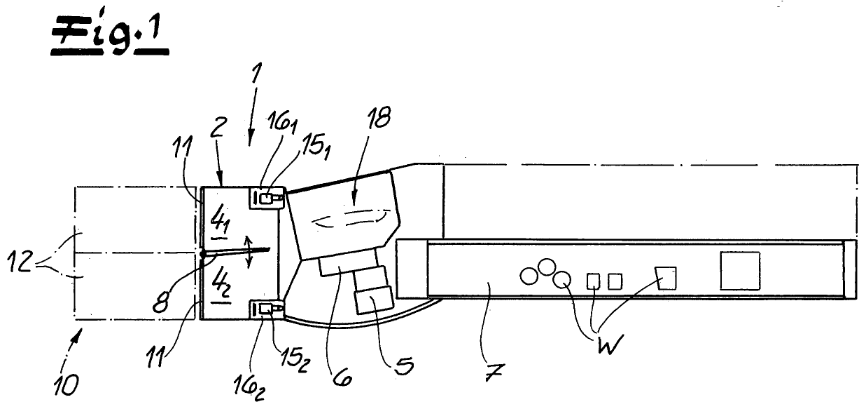

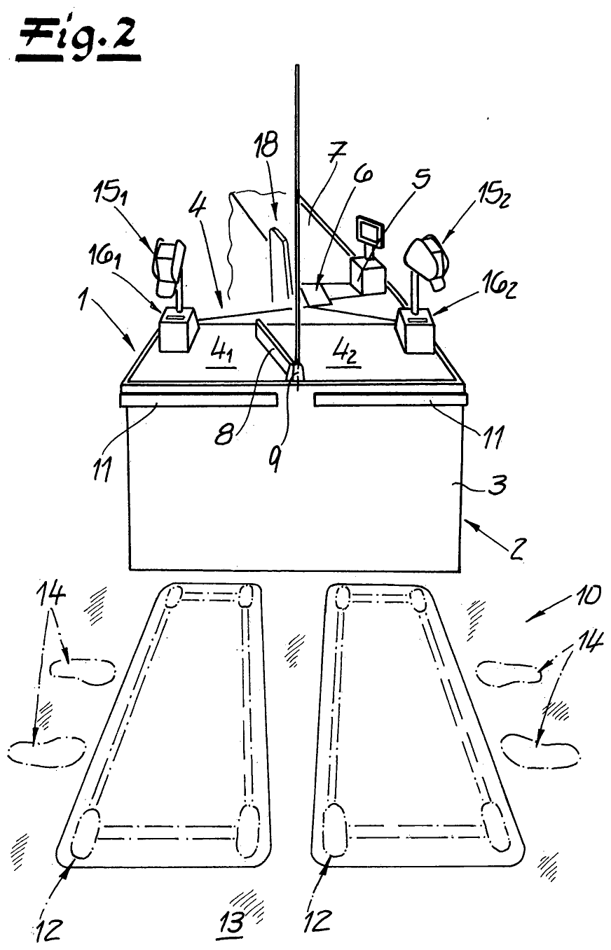

As seen in the drawing a till system according to the invention is intended for use with goods W. The goods W are not restricted to retail goods as shown in the schematic drawing in FIG. 1. To this end, the till system features a counter 1 built on a base 2 formed by several base elements. The drawing of FIG. 2 shows a base element 3 at the rear end that forms two goods bays 4 arranged at the downstream end as the goods flow from the front end of the counter 1. In principle, the design may include more than two goods bays 4₁ and 4₂. The design as shown in the drawings does not depict the further option of providing one or more mirrors and one or more cameras that a cashier may use to inspect the contents of a shopping cart to verify that the customer has placed all goods W on the counter 1.

The general design of the till system also includes an electronic scanner 5 for the goods W and a payment or input device 6. A conveyor belt 7 transports the goods W along the counter. The electronic scanner 5 for the goods W according to this embodiment is a scanner, and in particular a barcode scanner used to scan the goods W in terms of quantity and price and to add up the total price in the input device 6. To this end, the electronic input device 6 has a digital display 19.

As explained above, two goods bays 4₁ and 4₂ are provided at the downstream end relative to the goods-flow direction of the counter 1. As is evident in particular in the top view of FIG. 1, the second goods bay 4₂ is in line with the conveyor belt 7, and the first goods bay 4₁ immediately adjoins the second goods bay 4₂ and is offset relative to the conveyor belt 7. Both goods bays 4₁ and 4₂ are separated from one another by an arm or goods separator 8 that according to the embodiment can pivot about a vertical axis 9 between the illustrated solid line position allowing goods W to move straight back in the direction F into the goods bay 4₂ and into the position shown in broken lines deflecting the goods into the bay 4₁.

The two goods bays 4₁ and 4₂ open downstream at an angle toward a downstream parking station 10 for shopping carts that are not explicitly shown. The shopping cart parking station 10 downstream of the goods bay 4₁ and 4₂ has bumpers 111 and 112 for the shopping carts at the goods bays 4₁ and 4₂ as well as indicia 12₁ and 12₂ to indicate the proper positions for the respective shopping carts. The indicia 12₁ and 12₂ are on the floor 13. They may be painted or otherwise applied. However, the indicia 12₁ and 12₂ may also be designed and implemented as a contactless projection. The drawing also shows additional indicia 141 and 142 for the customers in the form of stylized footprints oriented crosswise to the indicia or imprints 12₁ and 12₂ for the shopping carts on the floor 13.

As shown here and according to the invention, a separate electronic payment device 15₁, 16₁; 15₂, 16₂ is allocated to each goods bay 4₁ and 4₂. The two payment devices 15₁, 16₁; 15₂, 16₂ comprise respective card readers 15₁ and 15₂ and printers 16₁ and 16₂. The printers 16₁ and 16₂ can generate a receipt after completing the electronic payment transaction, which not only lists the amount paid, but also the goods purchased by the respective customer.

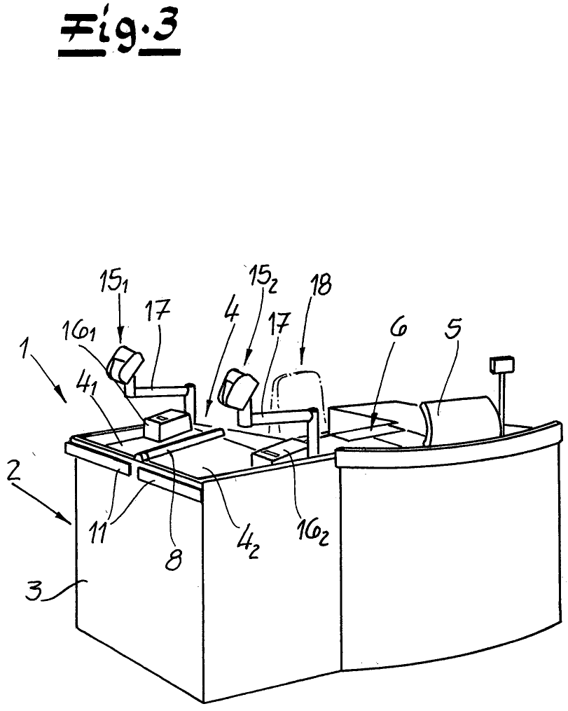

As shown in the drawing, both payment devices 15₁, 16₁; 15₂, 16₂ and/or their respective card readers 15₁ and 15₂ are carried on respective arms 17₁ and 17₂ that in this embodiment can pivot about respective vertical axes. This is depicted particularly clearly in FIG. 3. The design is such that the pivotal arm in question and accordingly, the two payment devices 15₁, 16₁; 15₂, 16₂ laterally flank the base element 3 at the upstream end of the counter 1. This makes the two payment devices 15₁, 16₁; 15₂, 16₂ easily accessible for the respective customers, who ideally stand to the side of base element 3 and are able to process the electronic payment transaction from this position.

The design according to the invention is such that a separate payment device 15₁, 16₁ or 15₂, 16₂ is provided for each goods bay 4₁ and 4₂. Namely, the first electronic payment device 15₁, 16₁ is allocated to the first goods bay 4₁ and the second goods bay 4₂ features the second electronic payment device 15₂, 16₂.

In this manner, the checkout procedure may be such that, at least during a first customer's payment transaction at the first payment device 15₁, 16₁ of the first goods bay 4₁, the goods of a second customer may be scanned via the electronic scanner 5 and transferred to the second goods bay 4₂. In the embodiment shown in the front view of FIG. 2, the first goods bay 4₁ is on the left, while the second goods bay 4₂ is adjacent on the right.

In this manner, it is feasible to significantly speed up customer processing, as the cashier may already utilize the electronic scanner 5 to scan the goods W of the second customer while the first customer independently completes the payment transaction using the first payment device 15₁, 16₁. Since the payment transaction is effected independently for the first customer at the first payment device 15₁, 16₁, the cashier occupying the cashier station 18 is typically not involved in, or responsible for the payment transaction. At most, the cashier makes sure that the payment process is initiated and verified as necessary.

The design is such that the cashier occupying the cashier station 18 initiates the payment transaction of the first customer at the first payment device 15₁, 16₁ for the first goods bay 4₁ and then scans the goods W of the second customer via the electronic scanner 5. The status of the respective goods bay 4₁ and 4₂ may be shown on a digital display linked to the input device 6. This may be ensured by the controller of the input device 6 not explicitly shown and additionally by the display 19. This display 19 further indicates the corresponding status based on a color-coding scheme in the sense of “green,” “yellow,” and “red” for the corresponding goods bay 4₁ and 4₂, as explained in detail above. The display 19 also documents the customer's payment transaction.

Moreover, the design offers the option for the customer to either pay at the input device 6 or at the electronic payment device 15₁, 16₁; 15₂, 16₂ allocated to the corresponding goods bay 4₁ and 4₂. In case of a payment transaction of the respective first customer at the input device 6, the second customer's goods will not be scanned until the payment transaction has been completed, as the payment transaction at the input device 6 typically involves cash, which means it must be initiated and processed by the cashier at the station 18. That means that the cashier, unlike with an electronic payment transaction, is not available for the simultaneous scanning of the second customer's goods W during the payment transaction.

However, customers typically pay for goods W electronically, namely via the payment device 15₁, 16₁ or 15₂, 16₂. This enables a process in which the cashier occupying the cashier station 18 is able to scan the goods W of the second customer via the electronic scanner 5 and transfer them to the second goods bay 4₂ while the payment transaction of the first customer is being processed at the first payment device 15₁, 16₁.

Once all the goods of, for instance, one customer have been scanned and fed to the second bay 4₂, the cashier can pivot the separator 8 from the solid-line position of FIG. 1 in which the goods W travel directly into the second bay 4₂ and the broken-line position in which they are deflected somewhat transversely of the direction F into the first bay 4₁ ensuring the continuous processing described above.

From the bays 4₁ and 4₂ the goods can be moved by the cashier or, more likely, the customer into a cart in the respective cart position indicated by the indicia 12₁ or 12₂.

We claim:

1. A till system for goods, the system comprising:
a counter having an upstream end and a downstream end;
an input device at a cashier station between the ends;
a conveyor for displacing the goods along the counter in a direction from the upstream end toward the downstream end;
a scanner between the ends for identifying characteristics of the goods moved past the scanner by the conveyor and feeding data representing the identified characteristics of the goods to the input device;
first and second goods bays at the downstream end adapted to hold the scanned goods and transversely spaced with respect to the direction; and
respective separate first and second payment devices at the first and second good bays for processing payments for the goods in the respective bays such that, while payment is being processed for the goods in one of the bays, goods can be scanned and fed to the other of the bays.

2. The till system according to claim 1, further comprising:
first and second support arms in the first and second goods bays for supporting the respective payment devices.

3. The till system according to claim 1, wherein the first and second payment devices laterally flank the first and second good bays.

4. The till system according to claim 1, wherein each payment devices comprises a respective card reader and printer.

5. The till system according to claim 1, further comprising:
a separator at the goods bays movable between a first position guiding goods from the conveyor to the first goods bay and a second position guiding goods from the conveyor the second goods bay.

6. The till system according to claim 1, further comprising:
means immediately downstream of the goods bays defining first and second parking stations for the first and second goods bay.

7. The till system according to claim 6, further comprising:
first and second bumpers for shopping carts at the downstream end of the counter in the first and second parking stations.

8. The till system according to claim 6, wherein the means defining are indicia on a floor.

9. The till system according to claim 1, wherein the second goods bay is aligned in the direction with the conveyor belt.

10. A till system for goods, the system comprising:
a counter having an upstream end and a downstream end;
an input device at a cashier station to one side of the counter between the ends;
a conveyor for displacing the goods along the counter in a direction from the upstream end toward the downstream end;
a scanner between the ends for identifying and recording characteristics of the goods moved past the scanner by the conveyor and feeding data regarding the goods to the input device;
first and second goods bays at the downstream end adapted to hold the scanned goods and transversely spaced with respect to the direction;
a separating element at the goods bays movable between a first position guiding goods from the conveyor to the first goods bay and a second position guiding goods from the conveyor the second goods bay; and
respective separate first and second payment devices at the first and second good bays for processing payments for the goods in the respective bays such that, while payment is being processed for the goods in one of the bays, goods can be scanned and fed to the other of the bays.

11. A method of operating a system having:
a counter having an upstream end and a downstream end;
an input device at a cashier station between the ends;
a conveyor for displacing goods along the counter in a direction from the upstream end toward the downstream end;
a scanner between the ends;
first and second goods bays at the downstream end; and
respective separate first and second payment devices at the first and second good bays for processing payments for the goods in the respective bays,
the method comprising the steps of, for one customer:
a) displacing the goods of a first customer past the scanner;
b) identifying characteristics of the goods of the first customer moved past the scanner by the conveyor and feeding data representing the identified characteristics of the goods to the input device;
c) guiding the scanned goods of the first customer downstream of the scanner to the first goods bay;
d) when all of the goods of the first customer have been scanned, closing the sale;
e) while the first customer is processing a payment for the sale at the payment device of the first goods bay, repeating steps a) and b) with the goods of a second customer and guiding the goods of the second customer downstream to the second goods bay.

12. The method according to claim 11, wherein the first goods bay is aligned in the direction with the conveyor belt and guiding goods into second goods bay entails deflecting them transversely from the direction into the second goods bay.

13. The method according to claim 11, wherein a cashier at the cashier station pre-selects the status of the goods bay to be shown on a display.

14. The method according to claim 13, wherein the payment transaction of the customer is documented by the display.

15. The method according to claim 11, wherein the customer either pays at the input device or at an electronic payment device allocated to the customer's goods bay.

16. The method according to claim 11, wherein, when the first customer is paying at the input device, the goods of the second customer are not scanned until the payment transaction of the first customer has been completed.
